(19) United States
(12) Patent Application Publication
(10) Pub. No.: US 2010/0287268 A1
(43) Pub. Date: Nov. 11, 2010

(54) METHODS, COMPUTER PROGRAMS, TRANSACTION SERVERS AND COMPUTER SYSTEM FOR IMPLEMENTING TRANSACTIONS

(76) Inventors: Göran Mikael Bergholm, Espoo (FI); Pekka Toivonen, Espoo (FI)

Correspondence Address: Studebaker & Brackett PC, One Fountain Square, 11911 Freedom Drive, Suite 750, Reston, VA, 20190, US

(21) Appl. No.: 12/678,629

(22) PCT Filed: Sep. 17, 2008
(86) PCT No.: PCT/FI08/00104

§ 371 Date: Jul. 27, 2010

(30) Foreign Application Priority Data
Sep. 17, 2007 (FI) 20075649

(51) Int. Cl. G06F 15/173

(52) U.S. Cl. 709/223

(57) ABSTRACT

The invention relates to a method, computer program and computer system for processing transactions. The method comprises providing a plurality of input connectors which interface towards a plurality of external data systems; providing a plurality of action connectors which interface towards a plurality of external data systems; receiving an input with one of the input connectors; determining, whether the input relates to a predetermined service of a customer; creating a transaction based on the input, when linking the received input to a predetermined service of a customer; processing the transaction to determine at least one output action; providing the at least one output action to at least one of the action connectors; and providing an output with the at least one action connector based on the at least one output action.

### FIELD OF THE INVENTION

The invention relates to transaction processing. Particularly, the invention relates to providing a predetermined response to an input in a communication network.

### BACKGROUND OF THE INVENTION

Today's world provides a wide variety of various information services e.g. via the Internet and telecommunication and other data communication networks. Because the amount of information transmitted in the networks is huge, it is often desirable to also manage or process the information at some point before it reaches its final destination. Nowadays it is desirable for many people to be able to determine how transactions (e.g. email messages, phone calls) are processed.

Email clients provide various rule based action, i.e. rules based on which incoming and/or outgoing emails can be processed. For example, a user may want that an email message with predetermined words in its subject field will be directly directed to a certain email folder.

In mobile phones, a user may determine a distinctive ringing tone for a caller. In another solution, the user may e.g. set his mobile phone to be in a silent alarm (silent ringing tone) except for one predetermined caller. Or when a called party does not answer to a phone call, the call may be automatically forwarded to the caller party's voice mail service.

What is common for all current solutions is the fact that they can be customized and managed only in their own dedicated environments. This provides only limited ways to process actions and transactions in the modern world. Therefore, there is a need for a solution that enables transaction processing in a versatile manner.

### SUMMARY OF THE INVENTION

The invention provides a solution with which it is possible to create a service only once and then attach connectors at input and output ends to cover as many clients and presentation formats as is wanted. In other words, the invention is able to receive input in any commonly used form (e.g. HyperText Transfer Protocol (HTTP), File Transfer Protocol (FTP), email, Short Message Service (SMS), voice calls, Multimedia Message Service (MMS), socket sessions, 2D code initiated http request, 1D code initiated http request etc.). Similarly, by using the action connectors, the solution disclosed in the invention is able to provide a response to the input in any commonly used form (e.g. http, file, email, SMS, MMS, voice call, socket session etc.). The same, an in advance created service, can be accessed by any of the above input forms. In short, the invention is able to provide any output after standardised transaction processing to any input.

According to one aspect of the invention, there is provided a method for processing transactions. The method comprises: providing a plurality of input connectors which interface towards any external client able to request a service; providing a plurality of action connectors which interface towards any external client able to receive data from a service; receiving an input with one of the input connectors; determining, whether the input relates to a predetermined service of a customer; creating a transaction based on the input, when linking the received input to a predetermined service of a customer; processing the transaction to determine at least one output action; providing the at least one output action to at least one of the action connectors; and providing an output with the at least one action connector based on the at least one output action.

According to one another aspect of the invention, there is provided a computer program comprising code adapted to perform the method according to the invention when executed on a data processing device.

According to one another aspect of the invention, there is provided a computer system for implementing transactions. The computer system comprises a plurality of input connectors which interface towards any external client able to request a service, configured to receive an input; a plurality of action connectors which interface towards any external client able to receive data from a service; transaction creation means configured to: determine, whether the input relates to a predetermined service of a customer; create a transaction based on the input, when linking the received input to a predetermined service of a customer; transaction processing means configured to: process the transaction to determine at least one output action; provide the at least one output action to at least one action connector. The at least one action connector is configured to provide an output based on the at least one output action.

According to one another aspect of the invention, there is provided a method for processing transactions. The method comprises: providing at least one input connector with customer and/or service information; receiving a transaction from at least one input connector; processing the transaction to determine at least one output action; and providing the at least one output action to at least one action connector.

According to one another aspect of the invention, there is provided a computer program comprising code adapted to perform the method of the above method when executed on a data processing device.

According to one another aspect of the invention, there is provided a transaction server for processing transactions. The transaction server comprises a first output interface configured to send to at least one input connector customer and/or service information; at least one input interface configured to receive a transaction from at least one input connector; transaction processing means configured to: process the transaction to determine at least one output action; provide the at least one output action to at least one action connector; and a second output interface configured to provide at least one output action to at least action connector.

Various embodiment of the invention are disclosed in the dependent claims.

The invention has various advantages over the prior art. In current solutions, one has to build several different services and each of the services maintains similar kinds of pieces of information. In the solution disclosed in the invention at hand, a plurality of existing services can be consolidated into one service and still get the same end result.

Furthermore, the introduction of forthcoming technologies is very easy because one has to implement only an input and action connector for a new technology. Other essential parts of the solution remain unchanged.

The solution disclosed in the invention is not limited to receive input only from a limited set of input sources. Similarly, the solution disclosed in the invention is not limited to provide a response or responses to the input to only a limited set of destinations. Furthermore, when a single service is created for a customer, the service can be used by any of the input connectors.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 discloses a general architecture view, in which the invention may be used, according to one embodiment of the invention;

FIG. 2A discloses a structure of a computer system according to one embodiment of the invention;

FIG. 2B discloses a structure of a transaction server according to one embodiment of the invention;

FIG. 3 discloses a table illustrating the structure of a transaction according to one embodiment of the invention;

FIG. 4 discloses a table illustrating the structure of a service according to one embodiment of the invention;

FIG. 5 discloses a table illustrating the structure of a trigger according to one embodiment of the invention;

FIG. 6 discloses a table illustrating the structure of a presentation according to one embodiment of the invention;

FIG. 7 discloses a table illustrating the structure of an action according to one embodiment of the invention;

FIG. 8 discloses a table illustrating the structure of a rule according to one embodiment of the invention;

FIG. 9A discloses an example of actions performed after receiving an input according to one embodiment of the invention; and

FIG. 9B discloses another example of actions performed after receiving an input according to one embodiment of the invention.

### DETAILED DESCRIPTION OF THE INVENTION

Reference will now be made in detail to the embodiments of the present invention, examples of which are illustrated in the accompanying drawings.

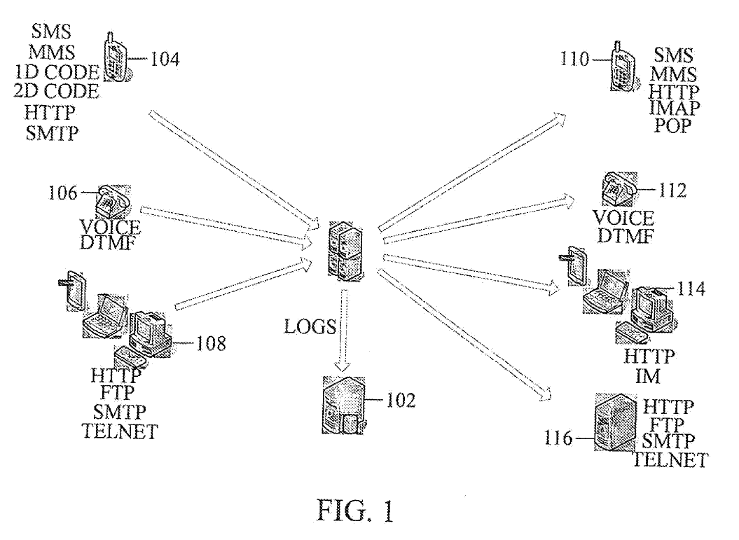

FIG. 1 illustrates one embodiment of an architecture in which the invention may be implemented. The core component of the invention is a transaction server 100. The transaction server 100 receives inputs from various sources, e.g. a mobile terminal 104, a land-line telephone 106 and data processing terminals 108 (e.g. a Personal Digital Assistant (PDA), a laptop computer, a personal computer etc.). The input refers e.g. to short messages, multimedia messages, Hypertext Transfer Protocol (HTTP) requests, Simple Mail Transfer Protocol (SMTP) requests, voice, Dual Tone Multi-frequency (DTMF) signals, File Transfer Protocol (FTP) requests, telnet requests etc. The transaction server 100 is configured to generate a transaction based on the input from one of the sources 104, 106, 108. The transaction server 100 processes the transaction, and in response to the processing, at least one output action is provided. An output action in any appropriate standardized form may be provided to any appropriate receiving terminal. The receiving terminal may be a mobile phone 110, a land-line telephone 112, a personal data processing terminal 114, a server 116 or any other terminal that can be reaches via a data or voice connection. The actual output action may take any appropriate form, e.g. a short message, a multimedia message, voice, DTMF signals, instant messaging (IM), HTTP, FTP, SMTP etc.

All actions relating to the transaction may be recorded in a log or logs 102 for further processing. The log 102 may be separate from the transaction server 100. Alternatively, it may be an internal part of the transaction server 100.

In a nutshell, the solution disclosed in the invention at hand is able to provide, in response to any input, any output in response to standardised transaction processing. With the invention at hand, it is possible to create a service only once and then attach connectors at input and output ends to cover as many clients and presentation formats as desirable.

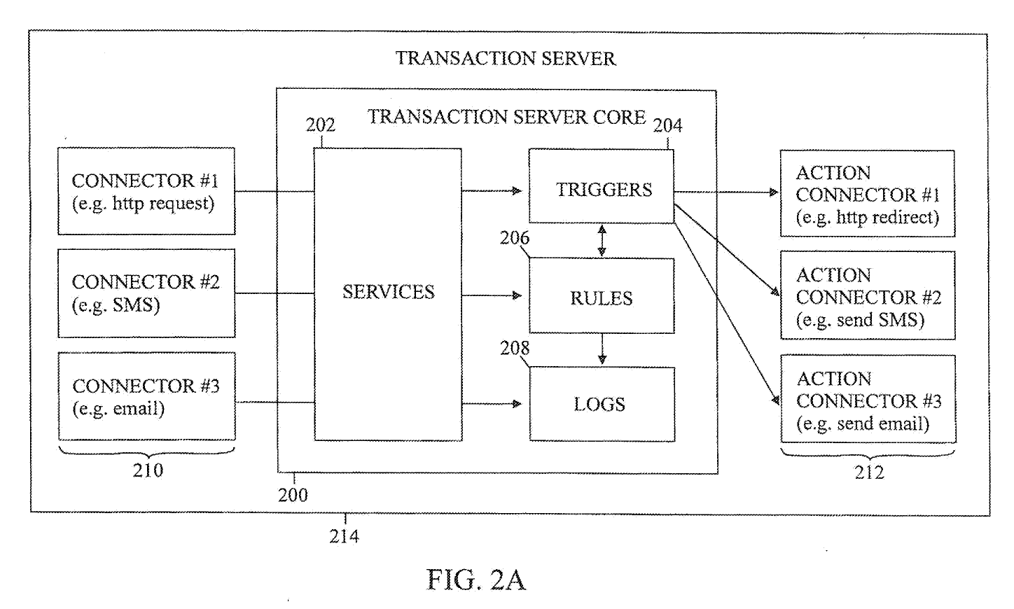

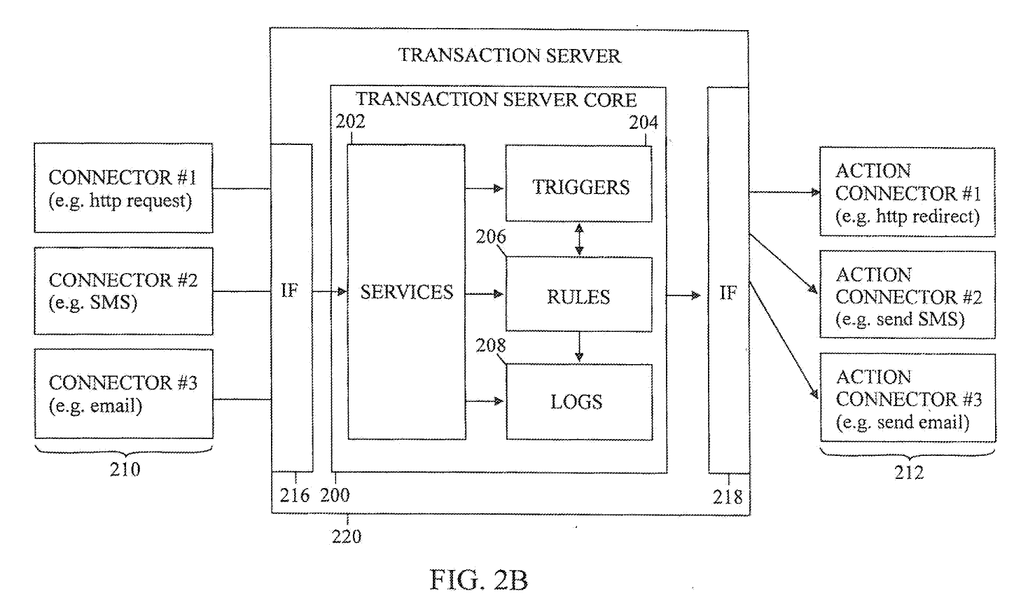

FIG. 2A discloses a more detailed structure of a computer system according to one embodiment of the invention.

A core 200 of a transaction server 214 comprises four logical modules: services 202, triggers 204, rules 206 and logs 208. Each of there will be discussed more thoroughly in the following paragraphs.

The transaction server 200 is configured to receive an input from a number of possible external clients able to request a service. The input is received with an input connector 210. An input connector 210 basically identifies a type of an input. The types include e.g. HTTP request, SMS, email etc. Similarly, the transaction server 214 is configured to provide an output for a processed transaction. FIG. 2 identifies these outputs as ‘action connectors’ 212. An action connector basically identifies an action type of an output.

In practice, an input connector 210 may be implemented is several ways. For example, regarding short messages (SMS), service providers provide messages to the transaction server in various forms. A common nominator for all forms is that the content of the message, sender and receiver number are known. A connector identifies these data elements and creates a transaction based on them.

If a service provider provides a received message e.g. in a HTTP get form, the connector is run in practice in a HTTP server. The HTTP server may be a script running in a dedicated server other than the transaction server or alternatively, the HTTP server may be implemented in the transaction server. The script provider provides the service provider with a predetermined response, and after that examines the content of data received from the service provider. If a transaction is created, the connector calls an interface (e.g. HTTP and XML (Extended Markup Language)) of the transaction server and receives an acknowledgement from the transaction server.

In another embodiment, a connector consists of a SMTP service that receives messages e.g. from service providers or other users. With virtual domains and/or public folders (a virtual user) it is possible to build a desired amount of ‘pipes’. For the sending party, the routing address may be a domain or an email address (a virtual user/folder). Every message received with the connector is scanned for keywords (i.e. service keys). For every pipe, there exists 0 . . . n different keywords (i.e. service keys). Each of the keywords corresponds with one service in the transaction server. If a match is found a transaction is created, and the connector calls an interface (e.g. HTTP and XML) of the transaction server and receives an acknowledgement from the transaction server. If the connector is implemented in the transaction server or in a virtual machine, a faster method than an http request can be used, e.g. a RPC (Remote Procedure Call) call to a transaction server core interface.

The interface in the transaction server towards the (input) connectors is e.g. a java library. The library contains enough classes and methods, e.g. “ask connector parameters” (e.g. keywords (service keys)), “create a transaction”, “modify parameters” etc. In one embodiment of FIG. 2A, the transaction server 214 performs the following steps for each transaction:
checking if the transaction belongs to a valid service
checking if the presentation attribute (e.g. ‘email’) is valid
checking if triggers exist for the service and presentation attribute combination
checking for each trigger if rules exist
performing actions defined by each trigger according to trigger rules.

The top level building blocks in the transaction server 214 are customers and services relating to each customer. Each customer is assigned a unique customer identifier (ID). Similarly, each service has a unique service identifier (ID). Unlike the customer ID, the service ID may be unique only within one customer ID. A service includes one or more triggers and each trigger may include one or more rules. Triggers and rules will be discussed in more detail shortly.

FIG. 2B discloses a structure of a computer system and especially a transaction server 220 according to another embodiment of the invention. In FIG. 2B input connectors 210 and output connectors 212 are implemented separately from the transaction server 220. Interfaces 216 and 218 provide connectivity towards the connectors. By using the architecture disclosed in FIG. 2B the input connectors 210 and output connectors 212 may reside in any appropriate location e.g. reachable via the Internet. The communication between the connectors and the transaction server 220 is implemented in any appropriate way via the Internet or other data or telephone communication network. Each of the elements, i.e. the input connector 210, the transaction server 220 and the output connector 212 may reside in physically separate places. For example, a customer A wants to use the transaction server service but also wants that an input connector is located in their own environment. The transaction server is maintained by a service provider B. The transaction server uses an output connector, which is provided by a partner C and the output connector in located in their own environment.

The same may also be expressed as with a real example. A client L lives in Frankfurt and uses a service of a Swedish service provider. The Swedish service provides uses a transaction server located in Helsinki of a Finnish service provider. The transaction server provides an output, which outputs data to an output connector of partner C located in San Francisco. The output connector on partner C transmits data to a logistics system in Singapore. Finally, the result of the chain is a purchased product which is delivered to Frankfurt to the client's home address.

In one embodiment of FIGS. 2A and 2B, the transaction server provides the input connectors with information (e.g. data relating to customers and services for them) needed in creating transactions. In other words, the transaction server e.g. tells to the input connectors that a service #s (in the transaction service) of a customer receives service requests from the input connectors if the an input connector receives input data containing a predetermined service key of the service #s.

In one embodiment, when an input connector receives input data from external clients, it requests from the transaction server (core) action instructions. The request may in practice be a database request to which the transaction server (core) returns one or more service keys. Then the input connector examines the input data. It should be noted that each input connector may differ from each other; a first input connector tries to find a character string (text) corresponding to the service keys, a second input connector performs logical comparisons, a third input connector examiner binary data etc. A common factor is that if a match if found, a transaction is created. In other words, the transaction server (core) “subscribes” transactions from different connectors by using service keys as parameters. It is important to notice that the transaction server (core) may subscribe from different input connectors with the same service key. Similarly, output may be provided with multiple output connectors in response to the same service key.

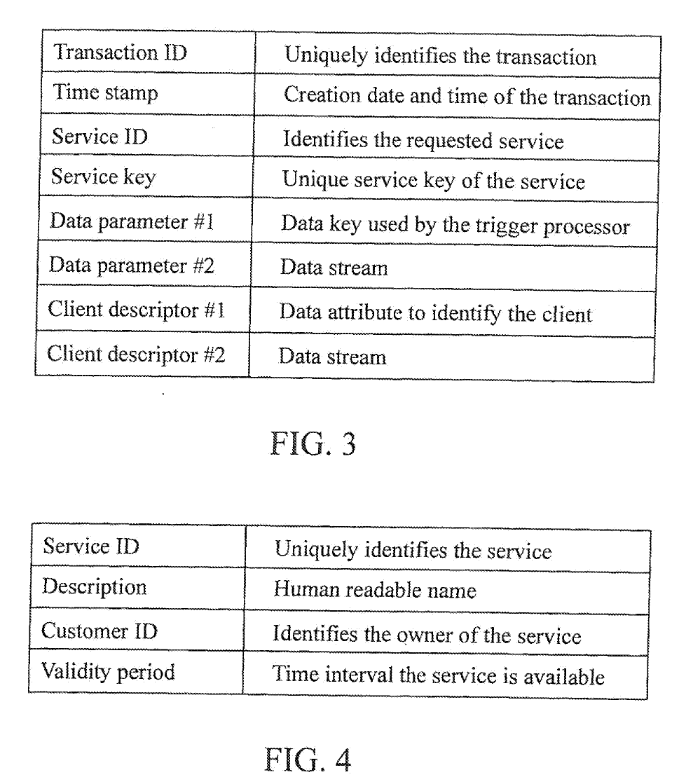

FIG. 3 discloses an embodiment of a transaction structure. A transaction is identified by a unique transaction identifier. ‘Time stamp’ contains the creation date and time of the transaction. ‘Service ID’ identifies the requested service. ‘Service key’ contains the unique service key. ‘Data parameter #1’ is a data key used by the trigger processor. ‘Data parameter #2’ includes a data stream. ‘Client descriptor #1’ includes a data attribute to identify the client. It e.g. identifies the format of a message (e.g. version, text/html etc.) ‘Client descriptor #2’ includes a data stream that identifies e.g. the email client that generated the email. This attribute may be set as definable.

A presentation attribute (‘Data parameter #1’) reveals which input connector created the transaction. Examples of possible presentation attributes include:

http request

ftp upload

email

2D code initiated http request

1D code initiated http request

socket sessions (telnet, ssh)

sms

mms

voice calls (dtmf, voice recognition)

etc.

FIG. 4 discloses an embodiment of a service structure. A service is a container of attributes. Each service has been assigned a service identifier that uniquely identifies the service. ‘Description’ provides a human readable name for service. ‘Customer ID’ provides a link to the customer to which the service belongs to. Each service may also comprise a validity parameter which contains the time interval the service is available for the customer.

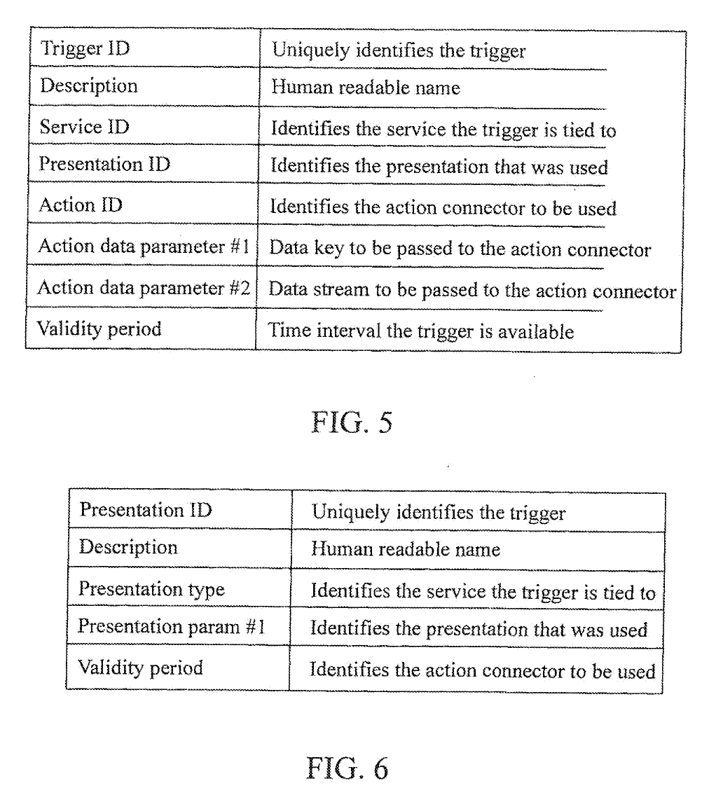

FIG. 5 discloses an embodiment of a trigger structure. A trigger binds together a presentation and an action. ‘Trigger ID’ uniquely identifies the trigger. ‘Description’ provides a human readable name for the trigger. ‘Service ID’ identifies the service to which the trigger is tied to. Each trigger contains an action identifier (ID) that identifies an action convector. ‘Action data parameter #1’ and ‘Action data parameter #2’ are data keys to be passed to the action connector. Each trigger may also comprise a validity parameter which contains the time interval the trigger is available.

If the trigger is valid the right action connector for the action is called. Examples of possible actions include:
http redirect
http fetch (load contents from remote http server and return to client)
return static file
return static page
send email
send sms
send mms
upload ftp file (static file)
upload ftp file (dynamic ally created file)
voice call, send a DTMF string
voice call, send audio file
socket session (telnet, ssh)
etc.

FIG. 6 discloses an embodiment of a presentation structure. Various types of presentations are connected to the transaction server core with the input connectors and the transaction server core identifies a presentation with a presentation identifier (ID). ‘Description’ provides a human readable name for the presentation. ‘Presentation type’ identifies the type of the presentation, e.g. http request, email, sms, mms, 2D code etc. Each presentation may also comprise a validity parameter which contains the time interval the presentation is enabled. New presentations can be added to the transaction server core at any time. A connector converts the actual (real-world) data stream to a standard transaction server transaction. Presentation param #1’ defines presentation specific properties, e.g. where to search for the service key in the received input data stream. Each presentation may also comprise a validity parameter which contains the time interval the presentation is available.

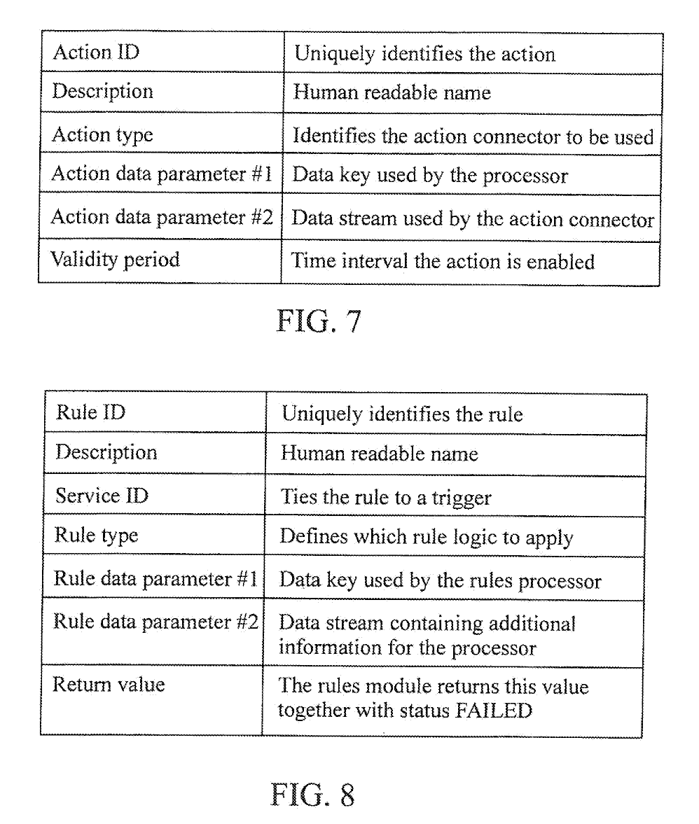

FIG. 7 discloses an embodiment of an action structure. Each trigger contains an action ID that references to an action connector (the reverse of an input connector). ‘Description’ provides a human readable name for the action. ‘Action type’ identifies the action type (i.e. action connector) to be used. Action data parameter #1’ is a data key used by the processor. ‘Action data parameter #2 ’ is a data key used by the action connector. Each trigger may also comprise a validity parameter which contains the time interval the action is enabled.

FIG. 8 discloses an embodiment of a rule structure. ‘Rule ID’ uniquely identifies the rule. ‘Description’ provides a human readable name for the rule. ‘Service ID’ ties the rule to a correct trigger. ‘Rule type’ defines which rule logic to apply. ‘Rule data parameter #1’ is a data key to be used by the rule processor. ‘Rule data parameter #1 ’ is a data key containing additional information for the processor. ‘Return value’ gives a value a rule module returns together with status FAILED. If a connector is by nature such that is returns to a source a return value, ‘Return value’ may be transmitted to the source as a return value of as a part of it. For example, in an email service in which a sender is a normal user, and a rule rejects the use of a connector (i.e. a transaction is aborted), ‘Return value’ can be used to return a cause for the rejection (e.g. ‘service closed’, ‘you do not have permission to use this service’ etc.). For example, if a HTTP connector receives data from another system (e.g. an automation system, a SAP system), ‘Return value’ may return e.g. a value ‘you have already provided this information. A rule contains attributes that define whether the action defined in the trigger shall be performed or not. Any number of rules (0 . . . n) can be applied for each trigger. Examples of possible rules include:
Enable trigger (between yyyy-mm-dd, hh:mm:ss and yyyy-mm-dd, hh:mm:ss)
Disable trigger (between yyyy-mm-dd, hh:mm:ss and yyyy-mm-dd, hh:mm:ss)
Counter (the action is performed on the Nth request)
User agent ENABLE (http only)
User agent DISABLE (http only)
IP address ENABLE
IP address DISABLE
Mobile # ENABLE
Mobile # DISABLE
Email-To ENABLE
Email-To DISABLE
Email-From ENABLE
Email-From DISABLE
Email-Subject ENABLE
Email-Subject DISABLE
Email-any field ENABLE
Email-any field DISABLE

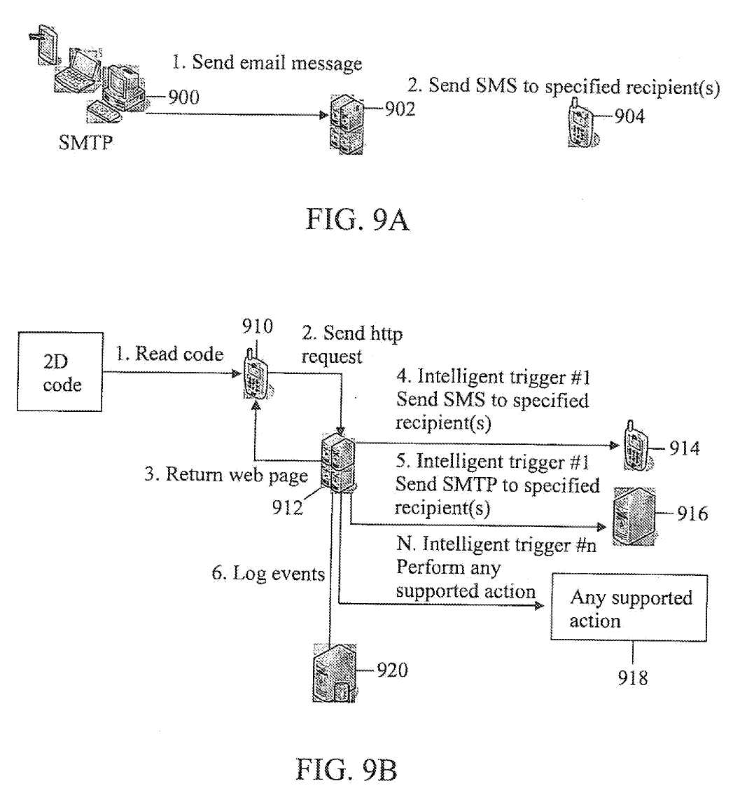

FIG. 9a discloses an example of actions performed after receiving an input according to one embodiment of the invention. In this embodiment, an input connector receives an email message. The trans-action server 902 reacts to every email message that contains a character string ‘n.n@abc.com’ from a sender 900. The functionality of the transaction server in roughly divided into two different aspects: service creation and service usage. Before a service can be used, it has to be created.

The service creation is first explained in more detail.

Each customer has his own customer identifier (ID). Let's assume that the customer ID in this case is #c. A service (#s) is created, which has a unique service key ‘n.n@abc.com’. The transaction server uniquely identifies a server based on the combination of #c and the service key. Thus different customers may have the same service key but the combination of #c and the service key is unique.

Next, a trigger is created for the service #s. In this example, the presentation ID is ‘email’. In other words, this trigger may be executed only to received emails. Next, the service creator chooses a desired action. In this case the action is to send a short message (SMS) to a predetermined recipient 904 every time when an email message of the customer #c contains a character string ‘n.n@abc.com’. Therefore, the action type is ‘send SMS.

The action data parameter #1 includes the mobile phone number to be used. The content of the short message is determined in the action data parameter #2. The short message may e.g. state that “An email received from a.a@abc.com” etc.

Now a service has been created. Based on the created service the transaction core tells to the input connector handling emails that the service #s receives service requests from the input connector when the service key of the service #s contains a value ‘n.n@abc.com’.

Next, the service usage (i.e. transaction processing) is explained in more detail. After the service creation, every time when the email input connector receives an email message, which contains (anywhere in the message) the character string ‘n.n@abc.com’, it creates a transaction.

The transaction structure disclosed in FIG. 3 now takes the following form:

TABLE 1

| | |
|---|---|
| Transaction ID | A new unique ID |
| Time stamp | Present time |
| Service ID | #s |
| Service key | “n.n@abc.com” |
| Data parameter #1 | Connector identifier, e.g. ‘email’ |
| Data parameter #2 | The received email message |
| Client descriptor | The format of the message (e.g. |
| #1 | version, text/html etc.) |
| Client descriptor | E.g. the email client that generated |
| #2 | the email (this value may be |
| | configurable) |

Next, the transaction server core processes the transaction. Based on the ‘Service ID’ (#s) the transaction server core determines and examines all triggers whose ‘Presentation ID’ equals to #p (this parameter is found from ‘Data parameter #1 ’ field of the transaction structure). Now, the previously created trigger calls the chosen action connector (‘send sms’) every time because we have not created any rules for the trigger.

Let's now go shortly back to the service creation process. We want to create two rules for the trigger. The rules return ‘OK’ if the rules are realized.

1. Email-From ENABLE with ‘a.a@abc.com’ parameter (if From field of the email includes ‘a.a@abc.com’, the rule returns ‘OK’).

2. Email-To ENABLE with ‘n.n@abc.com’ parameter (if To field of the email includes ‘n.n@abc.com’, the rule returns ‘OK’).

Now, the action of the trigger action is executed only if both rules return ‘OK’. In other words, the rules verify that the sender of the email message is ‘a.a@abc.com’ and the message want sent to ‘n.n@abc.com’.

In addition to the embodiment disclosed in FIG. 9, it is now additionally wanted that messages from address ‘a.a@abc.com’ to ‘n.n@abc.com’ are not wanted when the subject field of the email includes ‘Summer holiday’. To achieve this, a new rule is created for the trigger:

3. Email-Subject DISABLE with ‘Summer Holiday’ parameter.

Now, those emails whose sender is ‘a.a@abc.com’ and receiver ‘n.n@abc.com’ will trigger an action unless the subject field of the email includes ‘Summer Holiday’.

In addition to the above, if it is wanted that when an email message comes from ‘y.y@abc.com’, a short message should be sent and additionally a copy of the email message should be sent to ‘a.a@abc.com’. To achieve this, two new triggers are created.

In the first trigger the ‘Presentation ID’ is the same as above, i.e. ‘email’. The ‘Action type’ is now ‘send SMS’ the parameter of which is #mobile (mobile phone number). A new rule is created for this trigger:

4. Email-From ENABLE with ‘y.y@abc.com’ parameter.

In the second trigger the ‘Presentation ID’ is the same as above, i.e. ‘email’. The ‘Action type’ is now ‘send email’ with ‘a.a@abc.com’ parameter. A new rule is created also for this trigger:

5. Email-From ENABLE with ‘y.y@abc.com’ parameter.

In other words, if rule 4 returns ‘OK’, a short message is sent to #mobile. And, if rule 5 returns ‘OK’, a copy of the email message is sent to ‘a.a@abc.com’.

For example, a rule ‘Email-To ENABLE’ means that if the sender of an email (e.g. s.s@abc.com) corresponds to the address in the ‘Rule data parameter #2’ field, the rule returns ‘OK’.

In one embodiment, every processed transaction is recorded in a log 208. Data in the log 208 may be used e.g. for reporting purposes. All possible attributes are stored for reporting. Log entries are written e.g. to indexed database tables. In one embodiment, all phases of the transaction process are timestamped.

FIG. 9b discloses another example of actions performed after receiving an input according to one embodiment of the invention.

A mobile phone 910 read a 2D code e.g. from a paper or an advertisement. In response to the reading, the mobile phone 910 sends a HTTP request to a trans-action server 912. In response to receiving the HTTP request, the transaction server 912 returns to the mobile phone a web page or a HTTP address to a web page. In addition to this, the transaction server 912 may send a predetermined short message to a mobile 914, a predetermined email to a receiver 916 or it may perform any supported action 918. Each of the actions may be recorded in a log 920.

It is evident to a skilled person that although the above examples of the invention has been illustrated by using specific output examples, the output may take any appropriate form (e.g. data transmission, voice call, back coupling to an input connector, a product delivery, information processing, or any other predetermined action.

An essential aspect in the invention is that the transaction server is aware of various inputs. In other words, in one embodiment email messages must by routed through the transaction server. Similarly, if an action is required in response to an SMS, the transaction server need to know about the existence of the SMS e.g. from the teleoperator. The transaction server may then has to have interfaces to/from the existing network providers.

Each transaction processed by the transaction server is logged. In one embodiment, all possible attributes are stored for reporting. Log entries are written e.g. to indexed database tables. In one embodiment, all available transaction fields are stored and all phases of the transaction process are time-stamped. The data stored in the log may then be processed for various reporting purposes.

In one embodiment, the log records all available data relating to transactions and also progression data relating to transactions (e.g. status data of all transaction stages). Based on the log records, it is later possible to follow, analyze and model all stages of transactions. Furthermore, it is e.g. possible to analyze user behaviour of different service users based on the log records. This provides valuable information e.g. for service providers.

The transaction server may offer a special user interface (UI) layer for configuring and creating customers and services for them. The UI layer may e.g. provide tools to create different user interface consoles for various clients. The transaction server supports e.g. HTML and XML based solutions. With the user interface it is possible to build simple as well as complex user interfaces for controlling the transaction server. The user interface may be a basic web based user interface for a normal user, a more complex user interface e.g. for service providers.

The exemplary embodiments can include, for example, any suitable servers, workstations, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, trans-mission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDR, CD-RW, DVD, DVD-ROM, DVD±RW, DVD±R, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

1. A method for processing transactions, the method comprising:
providing a plurality of input connectors which interface towards any external client able to request a service;
providing a plurality of action connectors which interface towards any external client able to receive data from a service;
receiving an input with one of the input connectors;
determining, whether the input relates to a predetermined service of a customer;
creating a transaction based on the input, when linking the received input to a predetermined service of a customer;
processing the transaction to determine at least one output action;
providing the at least one output action to at least one of the action connectors; and
providing an output with the at least one action connector based on the at least one output action.

2. The method according to claim 1, further comprising;
creating a service for a customer, wherein the service is identified by at least a service identifier and a customer identifier; and
creating a trigger for the service, wherein the trigger comprises a trigger identifier, a service identifier, a presentation identifier, an action identifier and parameter data.

3. The method according to claim 2, further comprising:
creating a rule for the trigger, wherein the rule comprises a rule identifier, a service identifier and parameter data.

4. The method according to claim 2, wherein the service and/or trigger further comprises a validity period parameter.

5. The method according to claim 2, wherein the action identifier identifies an action, wherein an action comprises an action identifier, an action connector type and action parameter data.

6. The method accord to claim 5 wherein the action further comprises a validity period parameter

7. The method according to claim 2, wherein the presentation identifier identifies a presentation, where a presentation comprises a presentation identifier, an input connector type and presentation parameter data.

8. The method according to claim 7 wherein the presentation further comprises a validity period parameter.

9. The method according to claim 1, wherein a created transaction comprises a transaction identifier, a time stamp, a service identifier, a service key, a connector type, a presentation identifier, parameter data relating to the input.

10. The method according to claim 9, wherein the determining step further comprises:
determining, whether the input relates to a predetermined service of a customer, based on a service key of the service.

11. The method according to claim 9, wherein the processing further comprises:
determining a service identifier of the transaction;
examining those triggers whose presentation identifier matches with the presentation identifier of the transaction; and
calling an action connector identified by the action identifier of each trigger when rules have not been created for a trigger.

12. The method according to claim 9 wherein, the processing further comprises:
determining a service identifier of the transaction;
examining a trigger whose presentation identifier matches with the presentation identifier of the transaction;
examining at least one rule of the trigger; and
calling an action connector identified by the action identifier of the trigger when determining based on the at least one rule that an action is needed.

13. The method according to claim 1, wherein the method further comprises:
logging at least part of performed actions for further processing.

14. A computer program implemented on a data processing computer having a processor and memory and input and output devices, the computer program comprising code adapted to perform the method according to claim 1 when executed on the data processing computer.

15. A computer system for implementing transactions, the computer system comprising:
a plurality of input connectors which interface towards any external client able to request a service, configured to receive an input;
a plurality of action connectors with interface towards any external client able to receive data from a service;
transaction creation means configured to:
determine, whether the input relates to a predetermined service of a customer;
create a transaction based on the input, when linking the received input to a predetermined service of a customer;
transaction processing means configured to:
process the transaction to determine at least one output action;
provide the at least one output action to at least one action connector;
wherein the at least one action connector is configured to provide an output based on the at least one output action.

16. The computer system according to claim 15, further comprising service creation means configured to:
create a service for a customer, wherein the service is identified by at least a service
identifier and customer identifier; and
create a trigger for the service, wherein the trigger comprises a trigger identifier, a service identifier, a presentation identifier, an action identifier and parameter data.

17. The computer system according to claim 16, wherein the service creation means are further configured to:
create a rule for the trigger, wherein the rule comprises a rule identifier, a service identifier and parameter data.

18. The computer system according to claim 16, wherein the service and/or trigger further comprises a validity period parameter.

19. The computer system according to claim 16, wherein the action identifier identifies an action, wherein the action, wherein an action comprises an action identifier, an action connector type and action parameter data.

20. The computer system according to claim 19 wherein the action further comprises a validity period parameter.

21. The computer system according to claim 16, wherein the presentation identifier identifies a presentation, wherein a presentation comprises a presentation identifier, an input connector type and presentation parameter data.

22. The computer system according to claim 21 wherein the presentation further comprises a validity period parameter.

23. The computer system according to claim 15, wherein a created transaction comprises a transaction identifier, a time stamp, a service identifier, a service key, a connector type, a presentation identifier, parameter data relating to the input.

24. The computer system according to claim 21, wherein the transaction creation means are further configured to:
determine, whether the input relates to a predetermined service of a customer, based
on a service key of the service.

25. The computer system according to claim 22, wherein the transaction processing means are further configured to:
determine a service identifier of the transaction examine those triggers whose presentation identifier matches with the presentation identifier of the transaction; and
call an action connector identified by the action identifier of each trigger when rules have not been created for a trigger.

26. The computer system according to claim 23, wherein the transaction processing means are further configured to:
determine a service identifier of the transaction;
examine a trigger whose presentation identifier matches with the presentation identifier of the transaction;
examine at least one rule of the trigger; and
call an action connector identified by the action identifier of the trigger when determining
based on the at least one rule that an action is needed.

27. The computer system according to claim 15, wherein the computer system further comprises a log to which performed action are recorded for further processing.

28. The computer system according to claim 15, wherein the transaction creation means are implemented in each input connector.

29. The computer system according to claim 15, wherein input and output connectors are implemented in a external entity of the transaction processing means.

30. A method for processing transactions, the method comprising:
providing at least one input connector with customer and/or service information for transaction creation;
receiving a transaction from a least one input connector;
processing the transaction to determine at least one output action; and
providing the at least one output action to at least one action connector.

31. A computer program implemented on a data processing computer having a process, memory, and input and output devices, the computer program comprising code adapted to perform the method according to claim 30 when executed on the data processing computer.

32. A transaction server for processing transactions, the transaction server comprising:
a first output interface configured to send to at least one input connector customer and/or service information;
at least one input interface configured to receive a transaction from at least one input connector; transaction processing means configured to:
process the transaction to determine at least one output action;
provide the at least one output action to at least one action connector; and
a second output interface configured to provide at least one output action to least action connector.
